(19) United States
(12) Patent Application Publication
(10) Pub. No.: US 2009/0085487 A1
(43) Pub. Date: Apr. 2, 2009

(54) LIGHT SETS

(76) Inventor: Matthew P. Braasch, Northfield, IL (US)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 12/239,073

(22) Filed: Sep. 26, 2008

Related U.S. Application Data
(60) Provisional application No. 60/975,868, filed on Sep. 28, 2007.

(51) Int. Cl. F21S 4/00; B60Q 1/00

(52) U.S. Cl. 315/185 S; 362/227

(57) ABSTRACT

A light set including multiple circuits or light strings and utilizing a single set of electrical connectors. The electrical connectors include a male electrical connector for connection to an electrical power source, such as a wall outlet, and a female connector for receiving a male electrical connector of another light set. The multiple light strings allow a unique light size and electrical rating to be coupled to each light string. Moreover, the multiple light strings may be assembled to produce an array of aesthetically pleasing light arrangements utilizing the different sized lights.

### CROSS-REFERENCE TO RELATED APPLICATION

This application claims the benefit of U.S. Provisional Patent Application No. 60/975,868, filed Sep. 28, 2007, the entire contents of which are incorporated by reference herein.

### FIELD OF THE INVENTION

The present invention relates to light sets and, more particularly, to light sets having various ratings of lights and multiple circuits or light strings with a common set of electrical connectors for connecting the multiple circuits or light strings to an electrical power source.

### BACKGROUND

Many light sets include only a single rating bulb (i.e., same voltage, current, etc.), thereby providing only basic illumination capabilities without any contrast.

Existing light sets each include a pair of electrical connector plugs, one male and one female, and a single series of lights electrically connected in series between the pair of electrical connector plugs. When users desire numerous types, sizes, colors, etc. of lights, the users are required to utilize numerous light sets, thereby providing numerous sets of electrical connector plugs. Underwriters Laboratories (UL) safety standards set limits on the number of light sets that can be strung (i.e., male electrical plug of one light set connected to a female electrical plug of another light set) and set limits on the configuration of lights within each light set. Also, having numerous sets of electrical connector plugs is aesthetically unpleasing and users must perform many steps of plugging and unplugging the electrical connector plugs to set up and take down the numerous light sets.

Accordingly, a need exists for a light set that satisfies at least these and other deficiencies.

### SUMMARY

In some aspects, a light set is provided.

In other aspects, a light set is provided and includes lights having varying ratings.

In yet other aspects, a light set is provided and includes removable and replaceable lights of varying sizes and varying ratings.

In still other aspects, a light set is provided and includes multiple circuits or light strings utilizing a single set of electrical connectors. The electrical connectors comprise a male electrical connector for connection to an electrical power source, such as a wall outlet, and a female connector for receiving a male electrical connector of another light set.

Other aspects of the invention will become apparent by consideration of the detailed description and accompanying drawings.

### BRIEF DESCRIPTION OF THE DRAWINGS

FIG. 1 is a wiring schematic of a light set.

FIG. 2 is a perspective view of a portion of the light set shown in FIG. 1, shown with light bulbs in a connected condition.

FIG. 3 is a perspective view of the portion of the light set shown in FIG. 2, shown with the light bulbs in a disconnected condition.

FIG. 4 is a simplified electrical schematic of the light set shown in FIG. 1.

FIG. 5 is a wiring schematic of an alternative construction of a light set.

FIG. 6 is a perspective view of a portion of the light set shown in FIG. 5.

FIG. 7 is simplified electrical schematic of the light set shown in FIG. 5.

FIG. 8 is a wiring schematic of an alternative construction of a light set.

FIG. 9 is a simplified electrical schematic of the light set shown in FIG. 8.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

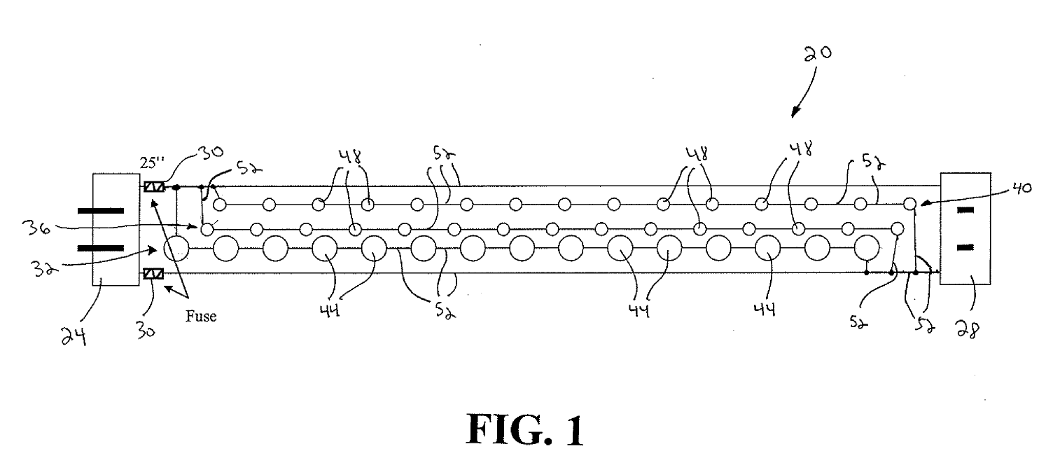

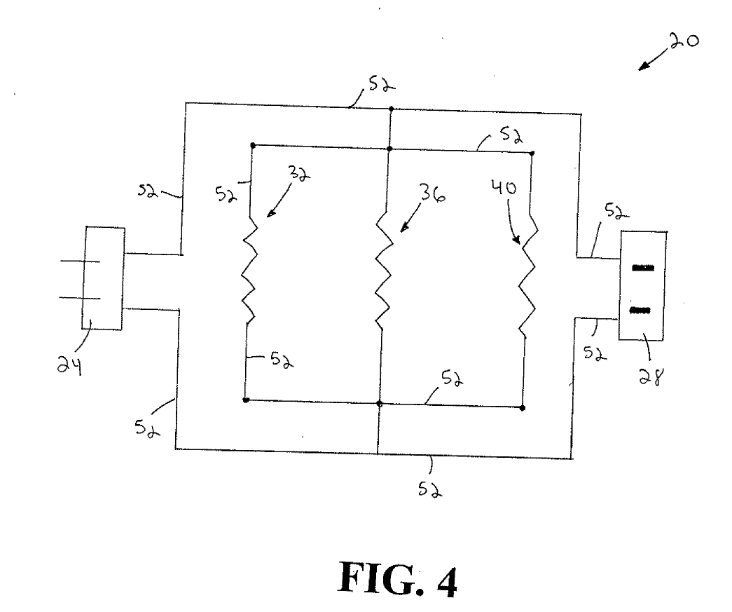

With reference to FIGS. 1-4, a light set 20 is illustrated and can be used for decorative and/or illuminative purposes. The light set 20 includes a set of electrical connectors comprising a male electrical connector 24 and a female electrical connector 28. The light set 20 also includes a pair of fuses 30 and a plurality of series circuits or light strings 32, 36, 40 electrically connected to, extending between, and sharing the single set of male and female electrical connectors 24, 28. With this configuration, the light strings 32, 36, 40 are in parallel with each other as shown in FIG. 4. In the illustrated construction, the light set 20 includes three separate light strings. In other constructions, the light set 20 can include other numbers of light strings. With the light set 20 including multiple light strings 32, 36, 40 and only a single set of electrical connectors 24, 28, only a single power source outlet is required to power multiple light strings and a user is only required to plug a single male electrical connector 24 into the power source outlet to illuminate multiple light strings 32, 36, 40.

With continued reference to FIGS. 1-4, the plurality of light strings comprises a first light string 32, a second light string 36, and a third light string 40. The first light string 32 includes a first type of light 44 having a first rating, and the second and third light strings 36, 40 include a second type of light 48 having a second rating different from the first rating. In the illustrated embodiment, the first type of light 44 is a larger sized light with a 4.5 volt and 0.4 amp rating, and the second type of light 48 has a smaller size than the first type of light 44 with a 4.5 volt and 0.1 amp rating. Alternatively, the first and second types of lights 44, 48 may have other ratings. Also, in the alternative, two of the light strings may include the first type of light 44 and only one light string may include the second type of light 48, or all three light strings may include the same type of light.

With particular reference to FIG. 1, the wiring of the light set 20 is illustrated and wires 52 are represented by the lines extending between the lights 44, 48, fuses 30, and electrical connectors 24, 28.

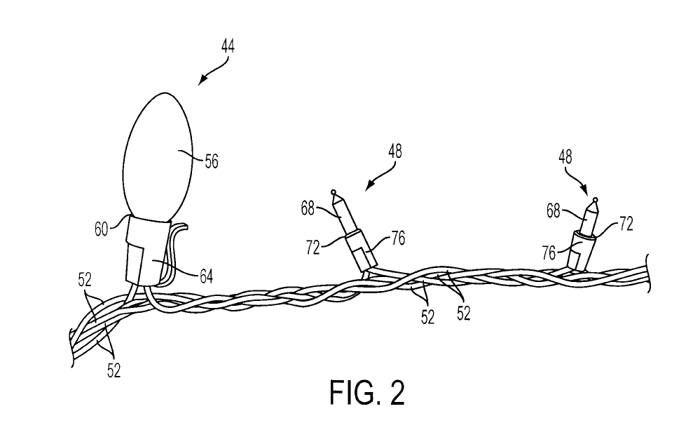

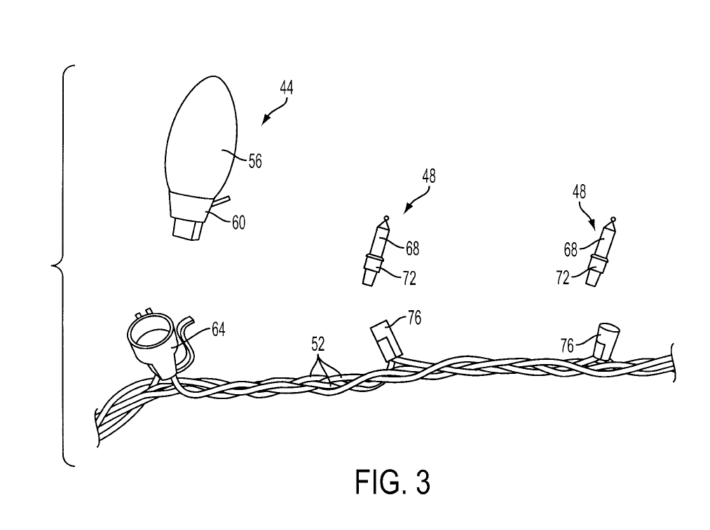

With reference now to FIGS. 2 and 3, the first and second types of lights 44, 48 are removable from the light set 20 to enable replacement of the lights 44, 48 when they burn-out, otherwise malfunction, or when a user desires a different color of light. The first type of light 44 includes a first bulb 56, a first bulb holder 60, and a first socket 64. The second type of light 48 includes a second bulb 68, a second bulb holder 72, and a second socket 76. The bulbs 56, 68 and bulb holders 60, 72 are secured together and are removable together from the sockets 64, 76 as shown in FIG. 3. A similar type of bulb and bulb holder is then placed into the socket to replace the removed bulb and bulb holder. For example, the removed first type bulb 56 and bulb holder 60 are replaced with another first type bulb 56 and bulb holder 60 and the removed second type bulb 68 and bulb holder 72 are replaced with another second type bulb 68 and bulb holder 72. Due to the significant size difference between the first and second types of lights 44, 48, a user cannot mistakenly place a second type of bulb 68 and bulb holder 72 into a socket 64 of the first type of light 44, and vice versa, and have the mistakenly placed light function.

When assembled (see FIG. 2), the light set 20 has the appearance of a single light string due to the wiring 52 and the single set of electrical connectors 24, 28. The light set 20 has the following light sequence: big light 44, small light 48, small light 48. This light sequence continues until termination near the female connector 28.

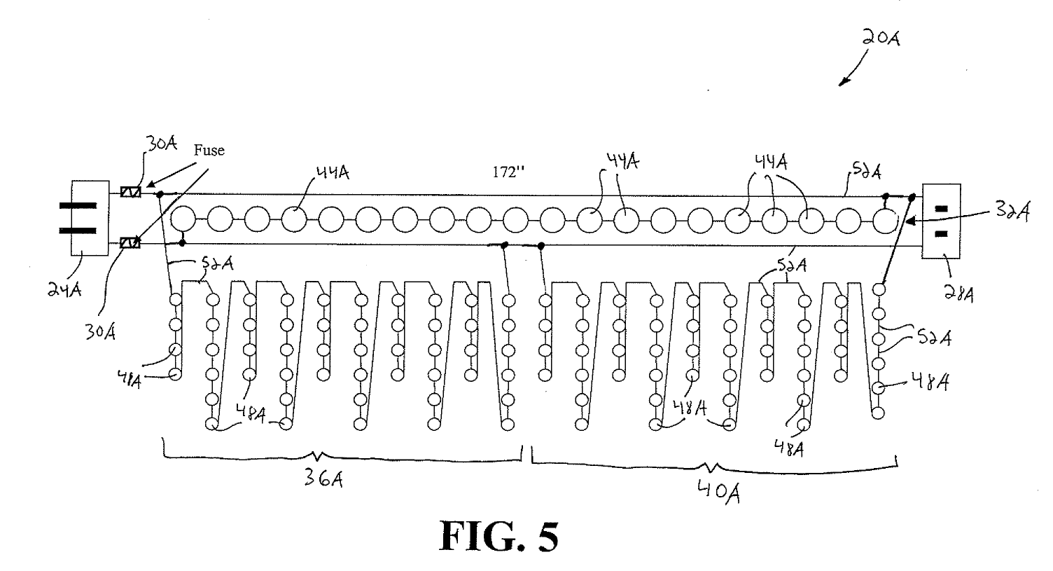

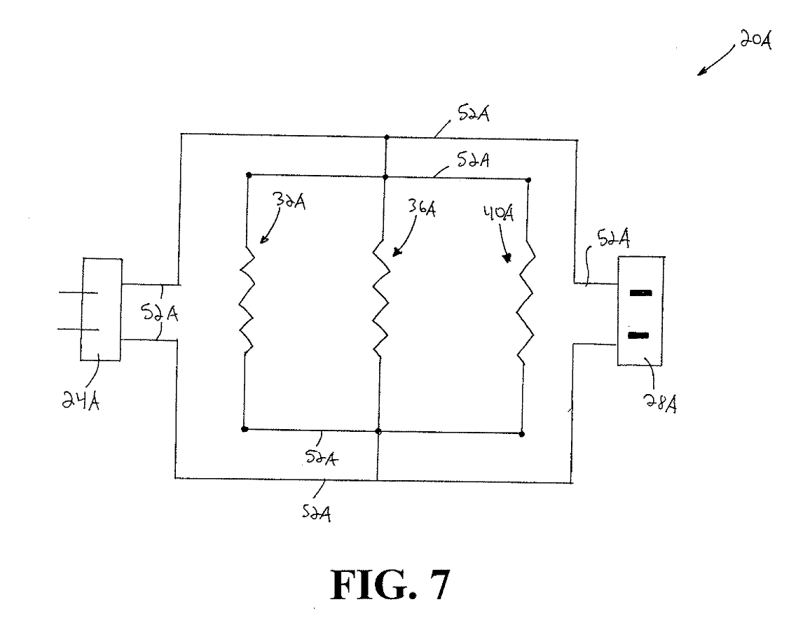

With reference to FIGS. 5-7, an alternative construction of a light set 20A is illustrated. Elements of the light set 20A illustrated in FIGS. 5-7 in common with elements of the light set 20 illustrated in FIGS. 1-4 are identified by the same reference number and an “A”. The light set 20A includes a plurality of series circuits or light strings 32A, 36A, 40A and the series circuits or light strings 32A, 36A, 40A are in parallel with each other as shown in FIG. 7. In the illustrated embodiment, the light set 20A includes three series circuits or light strings 32A, 36A, 40A. Similarly to the light set 20 illustrated in FIGS. 1-4, the light set 20A illustrated in FIGS. 5-7 includes a single set of electrical connectors 24A, 28A accommodating the numerous sets of light strings 32A, 36A, 40A. A first light string 32A includes a first type of light 44A, and the second and third light strings 36A, 40A include a second type of light 48A. In the illustrated embodiment, the first type of light 44A is a larger sized light with a 6.0 volt and 0.4 amp rating and the second type of light 48A has a smaller size than the first type of light with a 2.5 volt and 0.1 amp rating.

With particular reference to FIG. 5, the wiring of the light set 20A is illustrated and wires 52A are represented by the lines extending between the lights 44A, 48A, fuses 30A, and electrical connectors 24A, 28A.

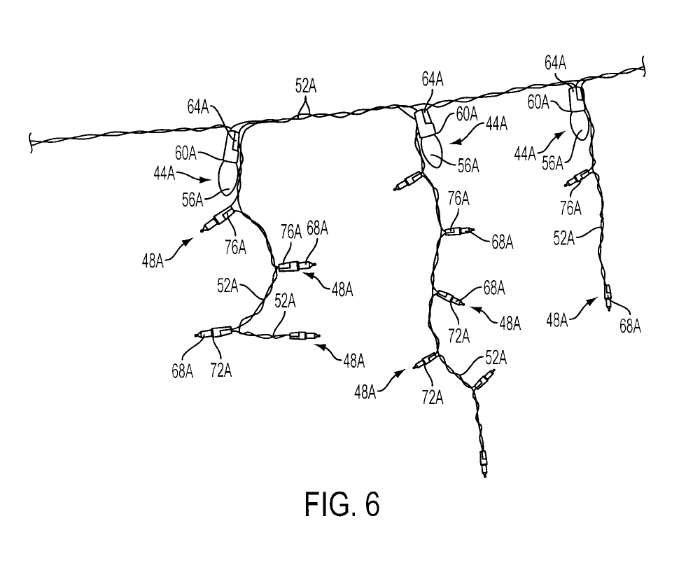

When assembled (see FIG. 6), the light set 20A has the appearance of a single light string due to the wiring 52A and the single set of electrical connectors 24A, 28A. The light set 20A also has the appearance of an icicle light appearance, which has the following sequence: a first big light 44A at the top with four small lights 48A dangling below the first big light 44A and a second big light 44A at the top following the first big light 44A with six small lights 48A dangling below the second big light 44A. This lighting sequence continues until termination near the female electrical connector 28A.

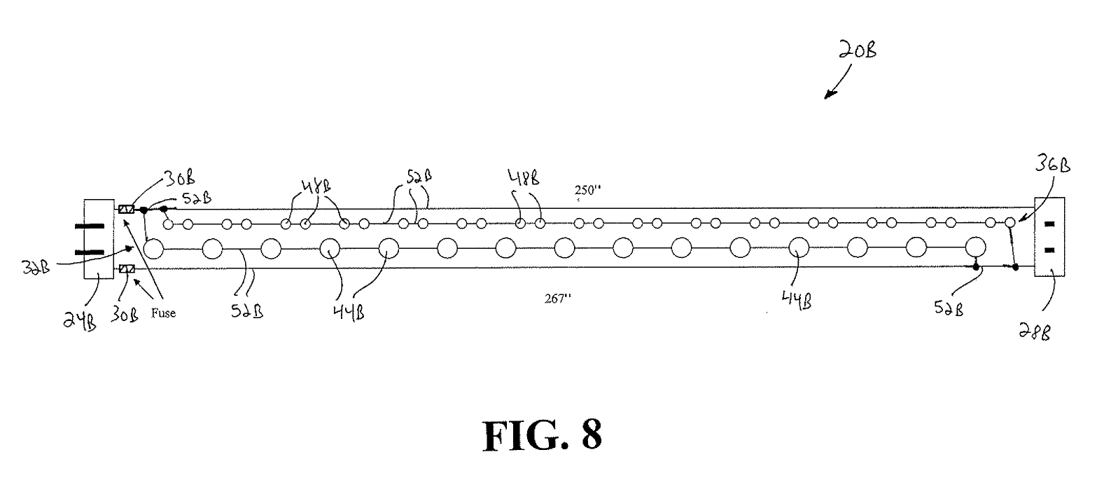

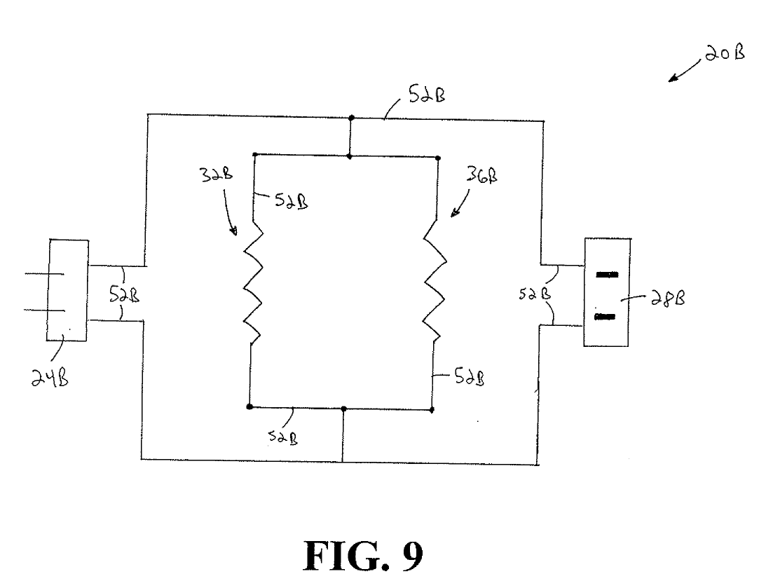

With reference to FIGS. 8 and 9, an alternative construction of a light set 20B is illustrated. Elements of the light set 20B illustrated in FIGS. 8 and 9 in common with elements of the light set 20 illustrated in FIGS. 1-4 and the light set 20A illustrated in FIGS. 5-7 are identified by the same reference number and a “B”. The light set 20B includes a plurality of series circuits or light strings 32B, 36B and the series circuits or light strings 32B, 36B are in parallel with each other as shown in FIG. 9. In the illustrated embodiment, the light set 20 includes two series circuits or light strings 32B, 36B. Similar to the light sets 20, 20A illustrated in FIGS. 1-7, the light set 20B illustrated in FIGS. 8 and 9 includes a single set of electrical connectors 24B, 28B accommodating the numerous sets of light strings 32B, 36B. A first light string 32B includes a first type of light 44B and the second light string 36B includes a second type of light 48B. In the illustrated embodiment, the first type of light 44B is a larger sized light with a 4.5 volt and 0.4 amp rating and the second type of light 48B has a smaller size than the first type of light 44B with a 2.5 volt and 0.1 amp rating.

With particular reference to FIG. 8, the wiring of the light set 20B is illustrated and wires 52B are represented by the lines extending between the lights 44B, 48B, fuses 30B, and electrical connectors 24B, 28B.

When assembled, the light set 20B has the appearance of a single light string due to the wiring 52B and a single set of electrical connectors 24B, 28B. The light set 20B has the following light sequence: big light 44B, small light 48B, small light 48B. This light sequence continues until termination near the female electrical connector 28B.

It should be understood that a large variety of alternatives and variations exist to the embodiments discussed above and illustrated in the drawings. One of ordinary skill in the art will be able to recognize such alternatives and variations from the disclosure herein and, therefore, such alternatives and variations are within the spirit and scope of the present invention.

1) A multi-circuit light set comprising:
a single male electrical connector;
a single female electrical connector;
a first light string electrically coupled to and extending between the male and female electrical connectors, the first light string including a plurality of first lights, each of the plurality of first lights having a first electrical rating; and
a second light string electrically coupled to and extending between the male and female electrical connectors, the second light string wired parallel to the first light string and including a plurality of second lights, each of the second lights having a second electrical rating different from the first electrical rating.

2) The multi-circuit light set of claim 1, wherein the first lights are wired in series with each other, and the second lights are wired in series with each other.

3) The multi-circuit light set of claim 1, wherein each first light includes a first bulb, a first bulb holder, and a first socket, and wherein the first bulb is coupled to the first bulb holder, and the coupled first bulb and first bulb holder are removably received by the first socket.

4) The multi-circuit light set of claim 1, wherein each second light includes a second bulb, a second bulb holder, and a second socket, and wherein the second bulb is coupled to the second bulb holder, and the coupled second bulb and second bulb holder are removably received by the second socket.

5) The multi-circuit light set of claim 4, wherein the second bulbs, the second bulb holders, and the second sockets are substantially dissimilar from the first bulbs, first bulb holders, and the first sockets, respectively.

6) The multi-circuit light set of claim 1, wherein the first and second light strings are assembled to resemble a single light string.

7) The multi-circuit light set of claim 1, further comprising at least one additional light string wired parallel to the first and second light strings, the at least one additional light string including a plurality of lights each having a different electrical rating from the first and second electrical ratings.

8) The multi-circuit light set of claim 7, wherein the electrical ratings of each of the at least one additional light strings are different from each other.

9) The multi-circuit light set of claim 1, wherein each first light is a first size, wherein each second light is a second size different from said first size, and wherein a repeating sequence of lights in the form of a first light, a second light, a second light, extends between the male and female electrical connectors.

10) The multi-circuit light set of claim 1, wherein each first light is a first size, wherein each second light is a second size different from said first size, wherein a repeating sequence of lights in the form of a first light with a first number of second lights extending below said first light, a first light with a second number of second lights extending below said first light, extends between the male and female electrical connectors, and wherein said second number is different from said first number.

11) A method of assembling a multi-circuit light set, the method comprising:
coupling a plurality of first lights having a first electrical rating in series to define a first light string;
coupling a plurality of second lights having a second electrical rating in series to define a second light string;
coupling first ends of the first and second light strings to a single male electrical socket;
coupling second ends of the first and second light strings to a single female electrical socket, the first and second light strings thereby coupled in parallel with each other; and
assembling the first and second light strings to appear as a single light string.

12) The method of claim 11, wherein coupling the plurality of first lights includes:
coupling a first bulb with a first bulb holder; and
removably introducing the coupled first bulb and first bulb holder into a first socket coupled to the first light string.

13) The method of claim 11, wherein coupling the plurality of second lights includes:
coupling a second bulb with a second bulb holder; and
removably introducing the coupled second bulb and second bulb holder into a second socket coupled to the second light string.

14) The method of claim 11, wherein the first lights are a first size, and the second lights are a second size different from said first size, and wherein assembling the first and second light strings includes arranging the lights in a repeating sequence of a first light, a second light, a second light, between the male and female electrical connectors.

15) The method of claim 11, wherein the first lights are a first size, wherein the second lights are a second size, and wherein assembling the first and second light strings includes arranging the lights in a repeating sequence of a first light with a first number of second lights extending below said first light, a first light with a second number of second lights extending below said first light, between the male and female electrical connectors, and wherein said second number is different from said first number.
